(19) United States
(12) Patent Application Publication
(10) Pub. No.: US 2015/0098247 A1
(43) Pub. Date: Apr. 9, 2015

(54) BACKLIGHT ASSEMBLY AND DISPLAY DEVICE HAVING THE SAME

(71) Applicant: SAMSUNG DISPLAY CO., LTD., Yongin-si (KR)

(72) Inventors: Jung-Hoon SHIN, Seongnam-si (KR); Hyuk-Hwan KIM, Hwaseong-si (KR); Su-Chang RYU, Yongin-si (KR); Young-Chun KIM, Seoul (KR); Won-Jin KIM, Buyeo-gun (KR)

(73) Assignee: SAMSUNG DISPLAY CO., LTD., Yongin-si (KR)

(21) Appl. No.: 14/288,135

(22) Filed: May 27, 2014

(30) Foreign Application Priority Data
Oct. 7, 2013 (KR) 10-2013-0118889

(51) Int. Cl. F21V 8/00

(52) U.S. Cl. CPC G02B 6/0011
USPC 362/611

(57) ABSTRACT

A backlight assembly includes a light source, a circuit board on which the light source is disposed, a light guide plate having a light incident surface and a light emitting surface, a bottom case accommodating the light guide plate, a fixing frame coupled to the bottom case and fixing the circuit board, and a heat dissipation apparatus disposed between the light source and the light guide plate and including a light-transmitting unit that transmits light.

### CROSS-REFERENCE TO RELATED APPLICATION

This application claims priority under 35 U.S.C. §119 to and the benefit of Korean Patent Application No. 10-2013-0118889 filed in the Korean Intellectual Property Office on Oct. 7, 2013, the content of which is incorporated herein in its entirety by reference.

### BACKGROUND

1. Technical Field

Embodiments of the inventive concepts relate to a backlight assembly having improved heat dissipation performance and to a display device including the same.

2. Description of the Related Art

Recently, keeping pace with low-carbon green economic growth all over the world, light emitting diodes (LEDs) which are regarded as a low-pollution eco-friendly product are being increasingly used as a backlight of various liquid crystal displays in order to reduce the energy consumption and decrease the greenhouse gas.

A display device, e.g. a liquid crystal display (LCD), is a type of flat panel display (FPD) that is the most widely used these days, and is configured such that a liquid crystal layer is interposed between two substrates having electrodes, so that liquid crystal molecules of the liquid crystal layer are rearranged upon applying voltage to the electrodes, thereby adjusting the amount of transmitted light.

A display device which is not a self-light emitting device includes a display panel for displaying an image and a backlight assembly which supplies light to the display panel. The backlight assembly is classified into a direct type, an edge type, and a corner type according to the position of a light source.

Meanwhile, a heat dissipation structure of the backlight assembly through which heat generated by a light source is dissipated is very important to prevent backlight assembly performance from being deteriorated.

With respect to a corner-type backlight assembly in which a single or a few light sources are disposed at a corner of a light guide plate, or an edge-type backlight assembly in which a plurality of light sources are disposed at a side of a light guide plate in a row, it is a prior task of a product design to effectively dissipate heat generated from the light source such as LEDs.

### SUMMARY

Aspects of embodiments of the inventive concepts are directed toward a backlight assembly including a heat dissipation apparatus having a light-transmitting unit that is disposed between a light source and a light guide plate and transmits light.

Further, aspects of embodiments of the inventive concepts are directed toward a display device including the backlight assembly.

According to an embodiment of the inventive concepts, a backlight assembly includes a light source, a circuit board on which the light source is disposed, a light guide plate having a light incident surface and a light emitting surface, a bottom case accommodating the light guide plate, a fixing frame coupled to the bottom case and fixing the circuit board, and a heat dissipation apparatus disposed between the light source and the light guide plate and including a light-transmitting unit that transmits light.

The heat dissipation apparatus may further include a heat dissipation unit in which the light-transmitting unit is fixed, the heat dissipation unit surrounding the light source and coupled to at least one of the fixing frame and the bottom case.

The heat dissipation apparatus further may include a heat sink extending substantially perpendicular to the light-transmitting unit.

The heat dissipation apparatus may be coupled to the circuit board on at least one side surface and a front surface of the circuit board.

The backlight assembly may further include a coupling member disposed on any one of the fixing frame and the heat dissipation unit, and a coupling groove formed on the other one of the fixing frame and the heat dissipation unit.

The coupling member may include a protrusion portion and a coupling protrusion extending from at least one side of the protrusion portion, and wherein the coupling groove may include an insertion portion into which the coupling member is inserted and a coupling groove portion to which the coupling member is connected in a sliding manner.

The backlight assembly may further include a insertion hole formed on in the heat dissipation unit, a thread hole formed in the fixing frame, and a screw inserted into the insertion hole and the thread hole to couple and fasten the fixing frame and the heat dissipation unit together.

The heat dissipation apparatus may be in contact with at least one of the circuit board, the light source, the fixing frame, and the bottom case.

The backlight assembly may further include a heat dissipation member interposed between the fixing frame and the circuit board.

The fixing frame may be a metal heat sink.

The light guide plate may include at least one chamfered edge portion or more, and the light may be incident on the edge portion.

The bottom case may include a recessed storage portion to accommodate the fixing frame.

According to embodiments of the inventive concepts, the backlight assembly is configured such that a heat dissipation apparatus is disposed between a fixing frame and a circuit board to enhance a force of coupling between the fixing frame and the circuit board, so that the fixing frame and the circuit board are coupled to each other, thereby improving coupling reliability and heat dissipation performance.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and aspects of the inventive concepts will be more clearly understood from the following detailed description taken in conjunction with the accompanying drawings, in which:

FIG. 1 is an exploded perspective view of a display device according to an embodiment of the inventive concepts;

FIG. 2 is a coupled perspective view of a fixing frame and a heat dissipation apparatus which are accommodated in a bottom case;

FIG. 3 is a cross-sectional view taken along line A-A′ of FIG. 1;

FIG. 4 is a schematic cross-sectional view of a heat dissipation path of a backlight assembly of FIG. 3;

FIG. 5 is an exploded perspective view showing a coupling structure of a fixing frame and a heat dissipation apparatus according to a first embodiment of the inventive concepts;

FIG. 6 is a rear view illustrating the heat dissipation apparatus according to the first embodiment of the inventive concepts;

FIGS. 7A to 7C are coupled perspective views of the fixing frame and the heat dissipation apparatus illustrated in FIG. 5;

FIG. 8 is an exploded perspective view showing a coupling structure of a fixing frame and a heat dissipation apparatus according to a second embodiment of the inventive concepts;

FIG. 9A is a cross-sectional view taken along line B-B′ of FIG. 8; and

FIG. 9B is a cross-sectional view taken along line C-C′ of FIG. 8.

### DETAILED DESCRIPTION

Advantages and features of the inventive concepts and methods for achieving them will be made clear from embodiments described below in detail with reference to the accompanying drawings. The inventive concepts may, however, be embodied in many different forms and should not be construed as being limited to the embodiments set forth herein. Rather, these embodiments are provided so that this disclosure will be thorough and complete, and will fully convey the scope of the invention to those skilled in the art. The inventive concepts is merely defined by the scope of the claims. Therefore, well-known constituent elements, operations and techniques are not described in detail in the embodiments in order to prevent the inventive concepts from being obscurely interpreted. Like reference numerals refer to like elements throughout the specification.

The spatially relative terms “below”, “beneath”, “lower”, “above”, “upper”, and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device shown in the drawing is turned over, the device positioned “below” or “beneath” another device may be placed “above” another device. Accordingly, the illustrative term “below” may include both the lower and upper positions. The device may also be oriented in the other direction, and thus the spatially relative terms may be interpreted differently depending on the orientations.

The terminology used herein is for the purpose of describing particular embodiments only and is not construed as limiting the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of mentioned component, step, operation and/or element, but do not exclude the presence or addition of one or more other components, steps, operations and/or elements.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

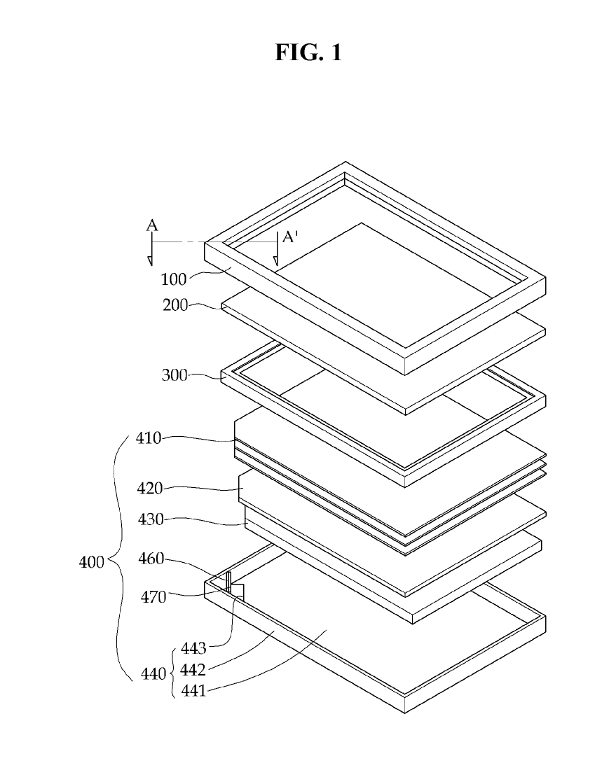

Hereinafter, a backlight assembly and a display device according to an embodiment of the inventive concepts will be described in more detail with reference to FIGS. 1 to 4. This specification includes an embodiment of a liquid crystal panel 200, but it is not limited thereto. In addition to the liquid crystal panel 200, any panel structure is available if it is capable of displaying an image by receiving light from a backlight assembly 400.

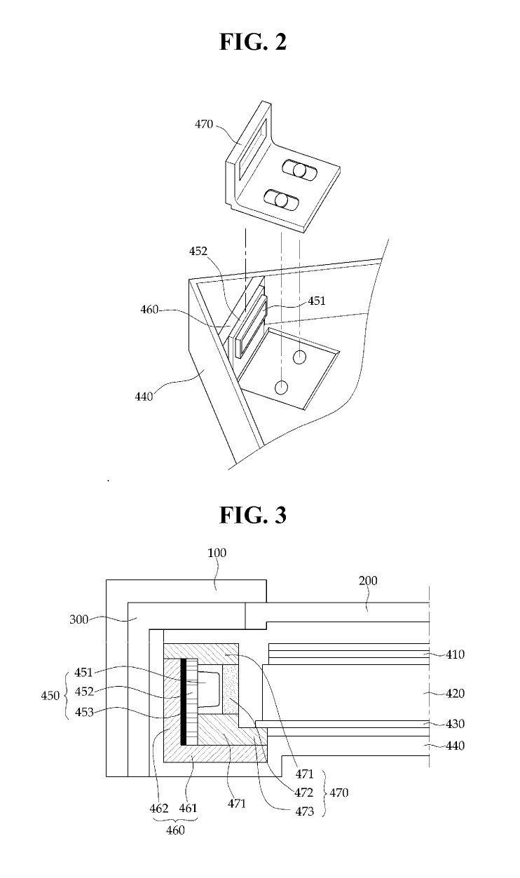

FIG. 1 is an exploded perspective view of a display device according to an embodiment of the inventive concepts. FIG. 2 is a coupled perspective view of a fixing frame and a heat dissipation apparatus which are accommodated in a bottom case. FIG. 3 is a cross-sectional view of the display device shown in FIG. 1, taken along line A-A′ of FIG. 1.

Referring to FIGS. 1 to 3, the display device includes a liquid crystal panel 200 that displays an image, a backlight assembly 400 that supplies light to the liquid crystal panel 200, a top case 100 covering the liquid crystal panel 200, and a mold frame 300 which connects the top case 100 to a bottom case 440 and on which the liquid crystal panel 200 is seated.

The mold frame 300 is coupled to the bottom case 440, and accommodates the liquid crystal panel 200. The mold frame 300 may be formed of a flexible material such as a plastic material in order to prevent the liquid crystal panel 200 from being damaged.

The top case 100 is coupled to the mold frame 300 and the bottom case 440 so as to cover the liquid crystal panel 200 seated on the mold frame 300. An open window is formed in the middle of the top case 100 to expose the liquid crystal panel 200.

The top case 100 may be connected to the mold frame 300 and the bottom case 440 by using hooks and/or screws. The top case 100 and the bottom case 440 may be coupled to each other through a variety of methods other than those mentioned above.

The backlight assembly 400 includes an optical sheet 410, a light guide plate 420, a reflective sheet 430, a bottom case 440, a light source unit 450, a fixing frame 460, and a heat dissipation apparatus 470.

The light source unit 450 includes a light source 451 and a circuit board 452 on which the light source 451 is disposed. The light source unit 450 may be disposed at a corner or a side of the light guide plate 420. That is, the light source unit 450 may emit light to a light incident surface of a corner portion or a side surface of the light guide plate 420. The light source 451 may include at least one LED chip, a phosphor coated on the LED chip and converting light emitted from the LED chip into light having a predetermined wavelength, and a package for accommodating the LED chip and the phosphor. The circuit board 452 may be, for example, a printed circuit board (PCB) or a metal core PCB. The light source unit 450 may be formed on one side surface, both side surfaces, or all of the four side surfaces of the light guide plate 420, or may be formed on at least one edge of the light guide plate 420 in consideration of the size, brightness or luminance uniformity of the light source and so on of a display panel 110.

The light source unit 450 may be coupled to the fixing frame 460 for rapid heat dissipation and fixing. A variety of methods, e.g., screws, hooks, and the like, may be employed to fix the light source unit 450 to the fixing frame 460.

Meanwhile, in the case where the light source unit 450 and the fixing frame 460 are connected to each other by using hooks or screws, a gap of about 10 μm to about 200 μm is formed between the light source unit 450 and the fixing frame 460 because of the limitation of a precision degree of manufacturing, and thus heat transfer may not be efficient.

Accordingly, in order to rapidly transfer heat generated by the light source unit 450, a heat dissipation member 453 having high thermal conductivity may be interposed between the circuit board 452 and the fixing frame 460, thereby fixing the light source unit 450 to the fixing frame 460. The heat dissipation member 453 may include a thermally conductive adhesive layer or a graphite sheet. Kinds of adhesive polymer resins of the thermally conductive adhesive layer is not particularly limited, and any resin well known as an adhesive in the art may be utilized. For example, an adhesive polymer resin, such as a silicone based resin, an acrylic resin, a urethane based resin, etc., may be used as the heat dissipation member.

The graphite sheet has an anisotropic thermal conductivity having a thermal conductivity in a horizontal direction higher than that in a vertical direction. Thus it transfers heat, which is generated by the LED chip of the light source unit 450, quickly in a horizontal direction, thereby reducing a problem caused by a heat generated by the LED chip.

The light source unit 450 may be further coupled to the heat dissipation apparatus 470 for rapid heat dissipation. As illustrated in FIG. 2, the heat dissipation apparatus 470 may be coupled to the fixing frame 460. For example, the light source 451 and the circuit board 452 may be disposed on the fixing frame 460, and the fixing frame 460 may be disposed at any one of corner portions of the bottom case 440. The heat dissipation apparatus 470 may be coupled to the light source 451, the circuit board 452, and the fixing frame 460.

An example of coupling the heat dissipation apparatus 470 to the light source unit 450 and the fixing frame 460 will be described in more detail later.

Light emitted from the light source 451 is incident on one surface of the light guide plate 420 and emitted to the other surface which faces the liquid crystal panel 200. The light guide plate 420 uniformly supplies light, which is generated by the light source unit 450, to the liquid crystal panel 200. The light guide plate 420 is accommodated in the bottom case 440. The light guide plate 420 may include at least one chamfered edge portion. Light from the light source 451 may be incident on the chamfered edge portion of the light guide plate 420. The light guide plate 420 may be provided in the form of, for example, a rectangular shape, substantially the same shape as the liquid crystal panel 200. However, the inventive concepts is not limited thereto, and in the case where LED is used as the light source 451, this plate may be formed in various shapes including predetermined grooves, protrusions, or the like according to the position of the light source 451.

The light guide plate 420 is described as a plate for ease of description, but it may be provided in the form of a sheet or a film to achieve slim display devices.

The light guide plate 420 may be formed of a transparent material having light transmission characteristics, such as, for example, an acrylic resin like polymethylmethacrylate (PMMA), or polycarbonate (PC), so as to guide light efficiently.

A pattern may be formed on at least one surface of the light guide plate 420. For example, the lower surface thereof may be formed with a scattering pattern (not shown) so as to guide light from the light source 451 upwards toward the liquid crystal panel 200.

The optical sheet 410 is disposed on the light guide plate 420, and plays a role in diffusing and collecting light transferred from the light guide plate 420. The optical sheet 410 may include a diffusion sheet, a prism sheet, and a protective sheet, and the like. The diffusion sheet may diffuse light received from the light guide plate 420 so as to prevent the light from hot spot. The prism sheet may be configured such that prisms having a triangular shape are formed in a predetermined array on one surface thereof, and this prism sheet is disposed on the diffusion sheet, and thus may play a role in collecting light diffused from the diffusion sheet in a direction perpendicular to the liquid crystal panel 200. The protective sheet may be formed on the prism sheet, and play a role in protecting a surface of the prism sheet and diffusing light to distribute the light uniformly to the liquid crystal panel 200.

The reflective sheet 430 is disposed between the light guide plate 420 and the bottom case 440, so that light emitted toward the bottom case 440 is reflected toward the liquid crystal panel 200, thereby increasing light efficiency.

The reflective sheet 430 may be formed of, for example, polyethylene terephthalate (PET) having reflectivity, and its one surface may be coated with a diffusion layer containing titanium dioxide, for example.

Meanwhile, the reflective sheet 430 may be formed of a material containing a metal such as Ag.

The bottom case 440 may include a bottom portion 441 and sidewall portions 442, and have a storage portion 433. The bottom portion 441 accommodates the reflective sheet 430 and the light guide plate 420, and is formed parallel to the light guide plate 420. The sidewall portions 442 may be bent upwards from the bottom portion 441. The storage portion 433 may be a recessed portion of the bottom portion 441 to accommodate the fixing frame 460. The bottom case 440 may be formed of a metal material having rigidity such as stainless steel or a material having good heat dissipation properties such as aluminum or aluminum alloys. The bottom case 440 of the present embodiment is responsible for maintaining a framework of the display device and protecting a variety of components accommodated therein.

The fixing frame 460 may be coupled to the bottom case 440 and may fix a printed circuit board 451 disposed thereon. The fixing frame 460 is disposed on one side of the bottom case 440, so that heat generated from the light source unit 450 is rapidly dissipated to the outside of the bottom case 440. The fixing frame 460 may perform a function of retaining the framework of the display device by being coupled to the bottom case 440, as well as dissipating the heat generated from the light source unit 450.

For the heat dissipation function, the fixing frame 460 may include a metal heat sink. In detail, a material of the fixing frame 460 may comprise a metal having high thermal conductivity or a powder having thermal conductivity, e.g., polymer including a metal powder.

A conventional fixing frame 460 covers only a rear surface and a bottom surface of the light source unit 450 and performs the heat dissipation function, and thus a heat dissipation path of the display device is only restricted to the rear surface and the bottom surface. As a result a heat dissipation efficiency is low. According to an embodiment of the inventive concepts, the heat dissipation apparatus 470 is configured to effectively dissipate heat from the light source 451 by diversifying the heat dissipation path.

The heat dissipation apparatus 470 includes a heat dissipation unit 471, a heat sink 473 extending substantially perpendicular to the heat dissipation unit and a light-transmitting unit 472 disposed between the light source and the light guide plate. The heat dissipation apparatus 470 absorbs heat emitted from the light source 451 and dissipates the heat through many different paths. The light-transmitting unit 472 of the heat dissipation apparatus 470 transmits the light from the light source 451 to the light guiding plate 420, prevent heat from the light source 451 from transferring into the light guiding plate 420 and transfers the absorbed heat to a heat dissipation unit 471 of the heat dissipation apparatus 470 so as to dissipate the heat. The light-transmitting unit 472 may include a transparent material, e.g., sapphire, zinc oxide, magnesium oxide, and the like, which have high thermal conductivity.

The heat dissipation unit 471 fixes the light-transmitting unit 472, extends substantially parallel to the vertical portion 462 of the fixing frame 460 and is coupled to at least one of the fixing frame 460 and the bottom case 440 to dissipate heat generated from the light source 451. The heat dissipation unit 471 is in contact with a front surface, side surfaces and an upper surface of the light source unit 450, and the fixing frame 460. The heat dissipation unit 471 transfers heat to the fixing frame 460 through diverse paths in order to dissipate the heat. The heat dissipation unit 471 may be formed of a metal having high thermal conductivity, a material such as ceramic, or the like.

The heat dissipation apparatus 470 may include at least one heat sink 473 that protrudes from a side surface of the heat dissipation unit 471 in a vertical direction. The heat sink 473 may have a rectangular shape, but the shape thereof is not limited thereto. The heat sink 473 may be integrated into the heat dissipation unit 471, and may be formed of the same material and be formed in one piece as the heat dissipation unit 471.

As long as the heat dissipation unit 471 is configured to be in contact with and cover both the light source unit 450 and the fixing frame 460, any shape of the heat dissipation unit 471 may be suitable. Shapes of the fixing frame 460, the light source unit 450, and the heat dissipation apparatus 470, and coupling relations therebetween will be described below in detail with reference to the accompanying drawings.

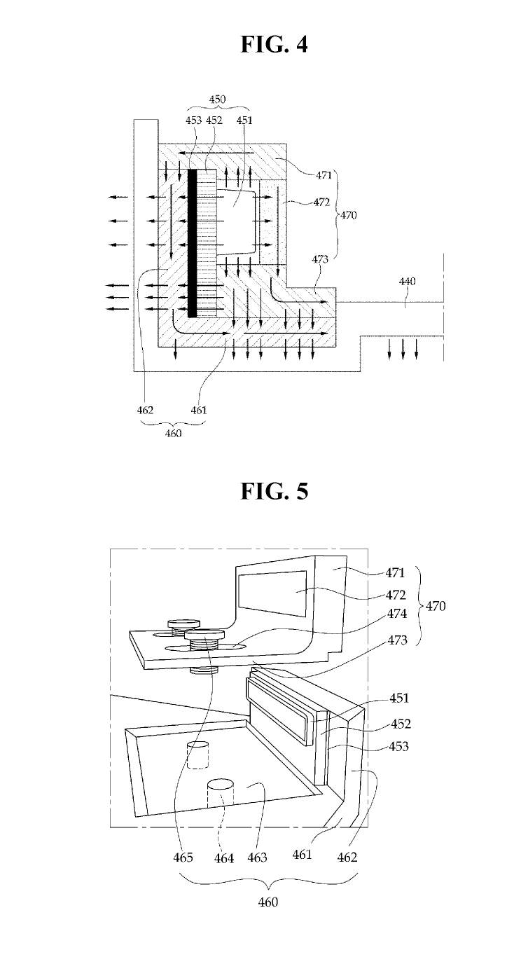

FIG. 4 is a schematic cross-sectional view of a heat dissipation path of a backlight assembly of FIG. 3. A variety of heat dissipation paths of a backlight assembly according to the heat dissipation apparatus 470 described above will be described as follows. The heat dissipation paths that will be described below may include a first path to a fourth path. The first path may be on the left side of the light source 451 as depicted in FIG. 4. The first path is a direction of the rear surface of the light source 451. The second path may be at the upper side of the light source 451 as depicted in FIG. 4. The second path is a direction of the upper surface of the light source 451. The third path may be on the right side of the light source 451 depicted in FIG. 4. The third path is formed in a direction of the front surface of the light source 451. The fourth path may be on the lower side of the light source 451 as depicted in FIG. 4. The fourth path is formed in a direction of the bottom surface of the light source 451.

With respect to the first path, heat generated from the light source 451 is transmitted to the fixing frame 460 through the circuit board 452 and the heat dissipation member 453. The heat transmitted to the fixing frame 460 is dissipated to the exterior through the bottom case 440 that is in contact with the fixing frame 460.

With respect to the second path, heat generated from the light source 451 is transmitted to the fixing frame 460 through the heat dissipation unit 471 disposed on the upper surface of the light source 451. The heat transmitted to the fixing frame 460 is dissipated to the exterior through the bottom case 440 that is in contact with the fixing frame 460.

With respect to the third path, heat generated from the light source 451 is transmitted to the heat dissipation unit 471 and the heat sink 473 through the light-transmitting unit 472 disposed on the front surface of the light source 451. The heat transmitted to the heat dissipation unit 471 and the heat sink 473 is also transmitted to the fixing frame 460. Thereafter, the heat transmitted to the fixing frame 460 is dissipated to the exterior through the bottom case 440 that is in contact with the fixing frame 460 exterior.

With respect to the fourth path, heat generated from the light source 451 is transmitted to the fixing frame 460 through the heat dissipation unit 471 and the heat sink 473 disposed on the bottom surface of the light source 451. The heat transmitted to the fixing frame 460 is dissipated to the exterior through the bottom case 440 that is in contact with the fixing frame 460.

In addition to the heat dissipation paths, although not illustrated in FIG. 4, heat of high temperature generated from the light source 451 is transmitted to the fixing frame 460 through the heat dissipation unit 471 covering the side surface of the light source 451, and the heat transmitted to the fixing frame 460 is dissipated to the exterior through the bottom case 440 that is in contact with the fixing frame 460.

Consequently, the heat of high temperature generated from the light source 451 is transmitted in all directions through the heat dissipation apparatus 470. The transmitted heat of high temperature is dissipated to the exterior through the fixing frame 460. That is, due to the heat dissipation apparatus 470, an area in which the heat of high temperature is in contact with a metal, etc., increases, and accordingly the heat of high temperature generated from the light source 451 is more rapidly and more effectively dissipated to the exterior through various heat dissipation paths.

Meanwhile, methods of transferring the heat may include conduction between metal surfaces that are in contact with each other, and convection by which the transferred heat may be emitted into the air. Further, the heat may be transferred by convection in space among the fixing frame 460, the light source unit 450, and the heat dissipation apparatus 470.

Hereinafter, a coupling structure of the fixing frame 460 and the heat dissipation apparatus 470 will be described in more detail with reference to FIGS. 5 to 9b.

FIG. 5 is a coupling structure of the fixing frame 460 and the heat dissipation apparatus 470 according to a first embodiment of the inventive concepts.

The first embodiment of the inventive concepts relates to a coupling structure of the fixing frame 460 and the heat dissipation apparatus 470 using a screw 465.

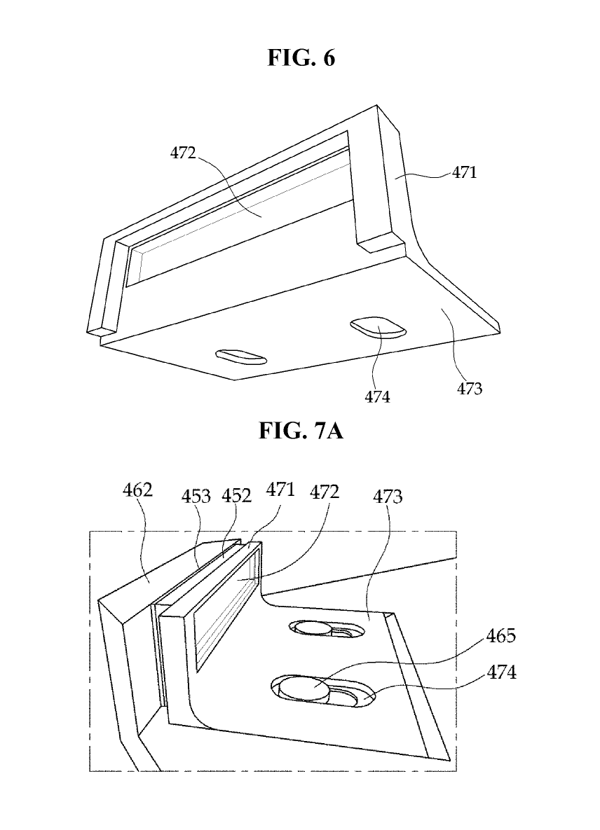

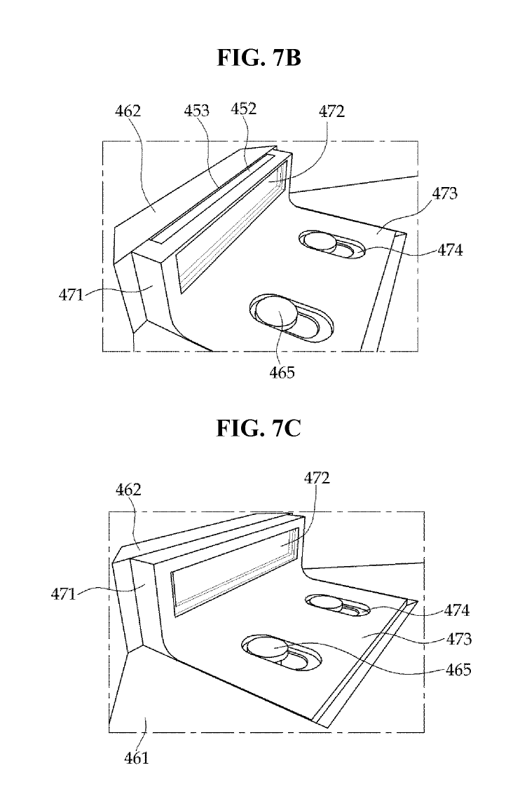

FIG. 5 is an exploded perspective view showing a coupling structure of the fixing frame 460 and the heat dissipation apparatus 470 according to the first embodiment of the inventive concepts. FIG. 6 is a rear view illustrating the heat dissipation apparatus 470 according to the first embodiment of the inventive concepts. FIGS. 7A to 7C are coupled perspective views of the fixing frame and the heat dissipation apparatus illustrated in FIG. 5.

First, referring to FIG. 5, the fixing frame 460 includes a horizontal portion 461 positioned inside the bottom case 440 and a vertical portion 462 disposed parallel to the sidewall portion 442 of the bottom case 440. The horizontal portion 461 may include a recessed portion 463 and a thread hole 464 on which the heat sink 473 of the heat dissipation apparatus 470 is seated.

The horizontal portion 461 is disposed parallel to the bottom portion 441 of the bottom case 440. The vertical portion 462 extends from an end of the horizontal portion 461 in a direction perpendicular to the horizontal portion 461. Herein, the horizontal portion 461 and the vertical portion 462 are terms used for the sake of expression, it is not essential that the horizontal portion 461 and the vertical portion 462 should be orthogonal to each other, and the horizontal portion 461 and the vertical portion 462 may have any shapes so long as they are connected to each other, and thus accommodate the light source unit 450 and the heat dissipation apparatus 470.

The vertical portion 462 may be formed parallel to the sidewall portion 442 of the bottom case 440, and the horizontal portion 461 and the vertical portion 462 may have a predetermined area in consideration of a heat dissipation effect, etc.

The horizontal portion 461 may include the recessed portion 463 on its upper surface to accommodate the heat sink 473 of the heat dissipation apparatus 470. For example, the recessed portion 463 may be formed to be a groove, so that the upper surface of the horizontal portion 461 has the same shape as the heat sink 473.

Further, the horizontal portion 461 may have a thread hole 464 into which the screw 465 may be inserted.

Referring to FIGS. 3, 5, and 6, the heat dissipation apparatus 470 includes the heat dissipation unit 471, the light-transmitting unit 472, the heat sink 473, and an insertion hole 474. As illustrated in FIG. 3, the heat dissipation unit 471 surrounds the light source 451. The light-transmitting unit 472 is disposed between the light source and the light guide plate 420. The heat dissipation unit 471 is disposed parallel to the vertical portion 462 of the fixing frame 460. The heat sink 473 may be formed at one end of the heat dissipation unit 471 extending in a vertical direction of the heat dissipation unit 471.

The heat dissipation unit 471 may include a sidewall protrusion to provide a space to accommodate the light source unit 450. For example, as illustrated in FIG. 6, the sidewall protrusion may have a staple shape formed on a rear surface of the heat dissipation unit 471. As illustrated in FIGS. 7A to 7C, when the heat dissipation unit 471 is coupled to the light source unit 450, the light source unit 450 is surrounded by the sidewall protrusion. As an embodiment of the inventive concepts, the sidewall protrusion is disclosed as having a staple shape, but it may have a variety of shapes, and a width and length thereof may be changed.

The light-transmitting unit 472 may have an area that is greater than a light beam or the same as the light beam so as to transmit light emitted from the light source 451.

The heat sink 473 may be parallel to the horizontal portion 461 of the fixing frame 460, and the heat sink 473 may have a rectangular shape, or although not illustrated, it may have a shape of heat dissipation fin, which is employed in a general heat sink, in order to have a wider heat dissipation area. The heat dissipation unit 471 and the heat sink 473 are not necessarily perpendicular to each other, and the heat sink 473 may have any shape if its structure allows emitting heat of high temperature and being coupled to the fixing frame 460.

Meanwhile, the insertion hole 474 may be disposed on any one of the fixing frame 460 and the heat dissipation unit 471, and the thread hole 464 may be disposed on any one of the fixing frame 460 and the heat dissipation unit 471. However, this is for exemplary purposes only, and the insertion hole 474 and the thread hole 464 may be appropriately disposed in consideration of a coupling structure and heat dissipation effect.

An assembly process of the fixing frame 460 and the heat dissipation apparatus 470 will be described below with reference to FIGS. 5 and 6. The screw 465 inserted into the insertion hole 474 of the heat dissipation apparatus 470 and the thread hole 464 of the fixing frame 460, so that the fixing frame 460 and the heat sink 473 are coupled to each other to be fixed. The heat sink 473 is seated in the recessed portion 463 of the fixing frame 460, and the heat dissipation unit 471 is in contact with the fixing frame 460.

As illustrated in FIG. 7A, the heat dissipation apparatus 470 is seated in the recessed portion 463, and is in contact with the circuit board 452 of the light source unit 450 and the horizontal portion 461 of the fixing frame 460.

As illustrated in FIG. 7B, the staple shaped sidewall protruding from the rear surface of the heat dissipation unit 471 covers the front surface and the side surface of the circuit board 452 by being in contact therewith and is in contact with the horizontal portion 461 and the vertical portion 462 of the fixing frame 460.

As illustrated in FIG. 7C, the staple shaped sidewall protruding from the rear surface of the heat dissipation unit 471 covers the front surface, the side surface, and the upper surface of the circuit board 452 concurrently by being in contact therewith and is in contact with the horizontal portion 461 and the vertical portion 462 of the fixing frame 460.

The structure of the heat dissipation unit 471 shown in FIGS. 7A to 7C is for exemplary purposes only. In consideration of coupling force, heat dissipation effect, and cost of the fixing frame 460 and the heat dissipation apparatus 470, the heat dissipation unit 471 may be formed in a variety of shapes, so that the light source unit 450 and the fixing frame 460 may be coupled to each other.

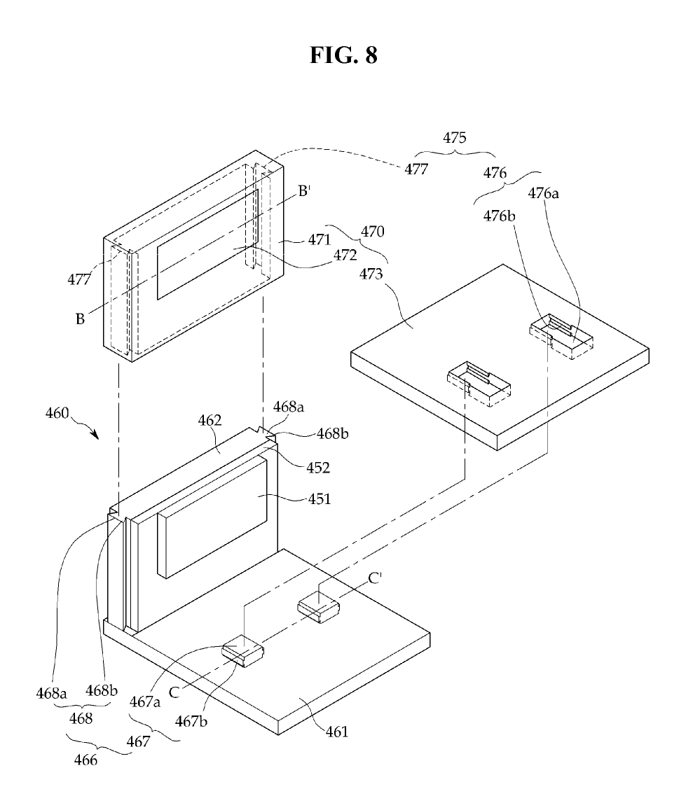

FIG. 8 is a coupling structure of the fixing frame 460 and the heat dissipation apparatus 470 according to a second embodiment of the inventive concepts.

The second embodiment of the inventive concepts relates to a structure of fixing by forming a dovetail protrusion on the fixing frame 460 as an example of hook coupling. Hereinafter, elements that are the same as those of the first embodiment will be omitted, and other elements that are different from those of the first embodiment will be described.

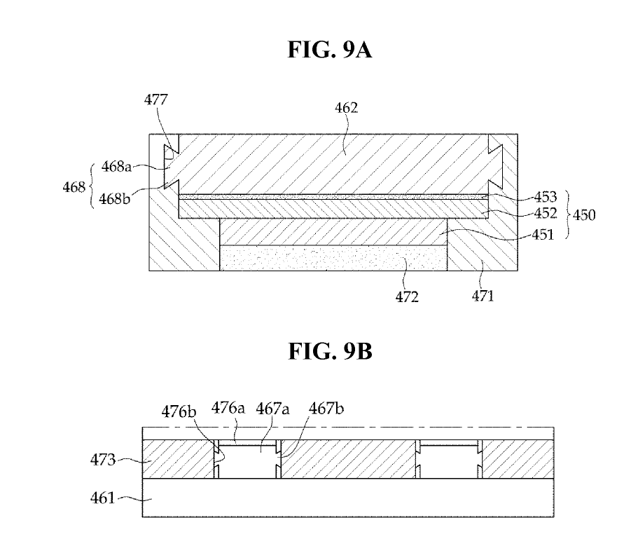

FIG. 8 is an exploded perspective view showing a coupling structure of a fixing frame and a heat dissipation apparatus according to the second embodiment of the inventive concepts. FIG. 9A is a cross-sectional view taken along line B-B′ of FIG. 8. FIG. 9B is a cross-sectional view taken along line C-C′ of FIG. 8.

According to the second embodiment of the inventive concepts, the heat dissipation apparatus 470 has a structure in which the heat dissipation unit 471 and the heat sink 473 may be separated from each other. However, this is not limited thereto, and the heat dissipation unit 471 and the heat sink 473 may be integrated with each other as in the first embodiment. The heat dissipation unit 471 and the heat sink 473 may be formed of a same material and be formed in one piece.

As illustrated in FIG. 8, the heat dissipation apparatus 470 may include at least one coupling groove 475, and the fixing frame 460 may include a coupling member 466 configured to be inserted into the coupling groove 475. Although not illustrated, the fixing frame 460 may include a coupling groove, and the heat dissipation apparatus 470 may include a coupling member correspondingly. In other words, the coupling member 466 may be disposed on any one of the fixing frame 460 and the heat dissipation unit 471, and the coupling groove 475 may be formed on the other one of the fixing frame 460 and the heat dissipation unit 471.

The coupling member 466 and the coupling groove 475 shown in FIG. 8 are for exemplary purposes only, and any position and shape are available if a structure thereof allows the heat dissipation apparatus 470 and the fixing frame 460 to be coupled to each other.

The coupling member 466 may include a first coupling member 467 and a second coupling member 468. The first coupling member 467 may have a protrusion 467a protruding from one surface of the horizontal portion 461 of the fixing frame 460, and a coupling projection 467b extending from at least one side of the protrusion 467a. The heat sink 473 and the horizontal portion 461 of the fixing frame 460 may be coupled to each other by the first coupling member 467.

The second coupling member 468 may have a protrusion 468a which protrudes from one surface of the vertical portion 462 of the fixing frame 460, and a coupling projection 468b extending from at least one side of the protrusion 468a. The heat dissipation unit 471 and the vertical portion 462 of the fixing frame 460 may be coupled to each other by the second coupling member 468.

The coupling member 466 may be formed by cutting the fixing frame 460. The coupling member may be formed using a mold (not shown) provided to shape the coupling member 466 on one surface of the horizontal portion 461. The other surface of the horizontal portion 461 is punched, whereby the coupling member 466 may be formed on the one surface of the horizontal portion 461. Accordingly, the other surface of the horizontal portion 461 may be provided with a recessed portion (not shown) at a position corresponding to the coupling member 466.

The coupling groove 475 may include a first coupling groove 476 and a second coupling groove 477. The first coupling groove 476 may include a first insertion portion 476a where the first coupling member 467 is inserted into the heat sink 473, and a second coupling groove portion 476b which extends from the first insertion portion 476a so that the first coupling projection 467b is caught therein.

The second coupling groove 477, into which the second coupling member 468 is inserted, may be formed on a sidewall protruding in a staple shape on the rear surface of the heat dissipation unit 471. The second coupling groove 477 may have a shape that covers the second protrusion 468a of the second coupling member 468 and the second coupling projection 468b.

The cross-section of the coupling groove 475 and the coupling member 466, which are mutually coupled, may have any one shape selected from the group consisting of a dovetail shape, a truncated triangular shape, a circular shape, a T shape, a rhombus shape, and a trapezoidal shape.

As illustrated in FIG. 9A, the vertical portion 462 of the fixing frame 460 and the light source unit 450 is covered by a protruding sidewall of the heat dissipation unit 471 of the heat dissipation apparatus 470. The vertical portion 462 and the heat dissipation unit 471 are coupled to each other by the second coupling member 468 and the second coupling groove 477.

The second protrusion (portion) 468a and the second coupling projection (protrusion) 468b of the second coupling member 468 have a dovetail shape. In the case where the cross-section of the second coupling member 468 has a dovetail shape, the second coupling projection 468b may have a taper structure.

In the drawing, the upper surface of the second coupling member 468 is shown to have a quadrangular shape, but the upper surface of the second coupling member 468 may have a circular shape. Also, the upper surface of the second coupling member 468 is shown to be flat according to the cross-section thereof, but may be curved in some embodiments. The cross-section of the second coupling protrusion 468b of the second coupling member 468 may have a circular shape or a circular shape a part of which is linearly cut. The width of the cross-section of the second coupling protrusion 468b is larger than that of the second protrusion portion 468a. Furthermore, the width of the upper surface of the second coupling protrusion 468b is in the range of the inner width of the second coupling groove 477 or may be equal to any one thereof.

Meanwhile, the inner surface of the second coupling groove 477 has a taper structure so as to be connected with the second coupling member 468.

As illustrated in FIG. 9B, the heat sink 473 of the heat dissipation apparatus 470 is in contact with the horizontal portion 461 of the fixing frame 460 to be seated on the horizontal portion 461. The horizontal portion 461 and the heat sink 473 are coupled to each other by the first coupling member 467 and the first coupling groove 476.

The first coupling member 467 is inserted into the first insertion portion 476a, and may slide in an extension direction of the first coupling groove 476, and then is connected with the first coupling groove portion 476b. In detail, the first protrusion portion 467a of the first coupling member 467 is inserted into the first insertion portion 476a, and thereafter the first protrusion portion 467a slides in the extension direction of the first coupling groove 476 so that the first coupling projection 467b extending from the first protrusion portion 467a may be inserted into the first coupling groove portion 476b to be connected therewith.

As described above, the coupling member 466 and the coupling groove 475 may have a variety of shapes, and an a width and length thereof may be changed in consideration of coupling force and heat dissipation effect of a coupling structure.

A coupling structure of the fixing frame 460 and the heat dissipation apparatus 470 according to a third embodiment of the inventive concepts will be described hereinafter.

Although not illustrated, a heat dissipation member is interposed between the fixing frame 460 and the heat dissipation apparatus 470, and thus the heat dissipation apparatus 470 may be fixed to the fixing frame 460.

For example, the heat dissipation member may be interposed between the horizontal portion 461 of the fixing frame 460 and the heat sink 473 of the heat dissipation apparatus 470, or between the vertical portion 462 of the fixing frame 460 and the heat dissipation unit 471 of the heat dissipation apparatus 470. The heat dissipation member may be used for a coupling structure of the fixing frame 460 and the heat dissipation apparatus 470 according to the first or second embodiment of the inventive concepts. The heat dissipation member preferably includes a thermally conductive adhesive layer or a graphite sheet. The kind of adhesive polymer resin of the thermally conductive adhesive layer is not particularly limited, and any resin usable as the adhesive in the art may be utilized. For example, an adhesive polymer resin, such as a silicone based resin, an acrylic resin, a urethane based resin, etc., may be used, and particularly useful is an acrylic resin.

From the foregoing, it will be appreciated that various embodiments of the inventive concepts have been described herein for purposes of illustration, and that various modifications may be made without departing from the scope and spirit of the present disclosure. Accordingly, the various embodiments disclosed herein are not intended to be limiting, with the true scope and spirit being indicated by the following claims, and equivalents thereof.

What is claimed is:

1. A backlight assembly comprising:
a light source;
a circuit board on which the light source is disposed;
a light guide plate having a light incident surface and a light emitting surface;
a bottom case accommodating the light guide plate;
a fixing frame coupled to the bottom case and fixing the circuit board; and
a heat dissipation apparatus disposed between the light source and the light guide plate and including a light-transmitting unit configured to transmit light.

2. The backlight assembly of claim 1, wherein the heat dissipation apparatus further includes a heat dissipation unit in which the light-transmitting unit is fixed, the heat dissipation unit surrounding the light source and coupled to at least one of the fixing frame and the bottom case.

3. The backlight assembly of claim 2, wherein the heat dissipation apparatus further includes a heat sink extending substantially perpendicular to the light-transmitting unit.

4. The backlight assembly of claim 3, wherein the heat dissipation apparatus is coupled to the circuit board on at least one side surface and a front surface of the circuit board.

5. The backlight assembly of claim 4, further comprising a coupling member disposed on any one of the fixing frame and the heat dissipation unit; and a coupling groove formed on the other one of the fixing frame and the heat dissipation unit.

6. The backlight assembly of claim 5, wherein the coupling member includes a protrusion portion and a coupling protrusion extending from at least one side of the protrusion portion, and
wherein the coupling groove includes an insertion portion into which the coupling member is inserted and a coupling groove portion to which the coupling member is connected in a sliding manner.

7. The backlight assembly of claim 4, further comprising:
a insertion hole formed in the heat dissipation unit;
a thread hole formed in the fixing frame; and
a screw inserted into the insertion hole and the thread hole to couple and fasten the fixing frame and the heat dissipation unit together.

8. The backlight assembly of claim 2, wherein the heat dissipation apparatus is coupled to the circuit board on at least one side surface and a front surface of the circuit board.

9. The backlight assembly of claim 2, further comprising a coupling member disposed on any one of the fixing frame and the heat dissipation unit; and a coupling groove formed on the other one of the fixing frame and the heat dissipation unit.

10. The backlight assembly of claim 9, wherein the coupling member includes a protrusion portion; and a coupling protrusion extending from at least one side of the protrusion portion, and the coupling groove includes an insertion portion into which the coupling member is inserted so as to be connected therewith; and a coupling groove portion to which the coupling member is connected in a sliding manner.

11. The backlight assembly of claim 2, further comprising
a insertion hole formed in the heat dissipation unit;
a thread hole formed in the fixing frame; and
a screw inserted into the insertion hole and the thread hole to couple and fasten the fixing frame and the heat dissipation unit together.

12. The backlight assembly of claim 1, wherein the heat dissipation apparatus further includes a heat sink extending substantially perpendicular to the light-transmitting unit, the heat sink coupled to the fixing frame.

13. The backlight assembly of claim 12, wherein the heat dissipation apparatus is coupled to the circuit board on at least one side surface and a front surface of the circuit board.

14. The backlight assembly of claim 1, wherein the heat dissipation apparatus is coupled to the circuit board on at least one side surface and a front surface of the circuit board.

15. The backlight assembly of claim 1, wherein the heat dissipation apparatus is in contact with at least one of the circuit board, the light source, the fixing frame, and the bottom case.

16. The backlight assembly of claim 1, further comprising a heat dissipation member interposed between the fixing frame and the circuit board.

17. The backlight assembly of claim 1, wherein the fixing frame comprises a metal heat sink.

18. The backlight assembly of claim 1, wherein the light guide plate comprises at least one chamfered edge portion or more, and the light is incident on the edge portion.

19. The backlight assembly of claim 1, wherein the bottom case includes a recessed storage portion to accommodate the fixing frame.
